(19) United States
(12) Patent Application Publication
(10) Pub. No.: US 2014/0196352 A1
(43) Pub. Date: Jul. 17, 2014

(54) Fishing Tip Pole

(71) Applicants: Tom Coveyou, St. Ignace, MI (US); Thomas Coveyou, St. Ignace, MI (US)

(72) Inventors: Tom Coveyou, St. Ignace, MI (US); Thomas Coveyou, St. Ignace, MI (US)

(21) Appl. No.: 13/744,346

(22) Filed: Jan. 17, 2013

(51) Int. Cl. A01K 97/01; A01K 97/12; A01K 87/04

(52) U.S. Cl. CPC A01K 97/01; A01K 87/04; A01K 97/12
USPC 43/17; 43/17.5

(57) ABSTRACT

A fishing tip pole that includes a base fishing rod that includes a first end, a fishing line run along the base fishing rod and into a body of water and a flag attached to the first end of the base fishing rod. The fishing tip pole also includes a reel attached to the base fishing rod, the reel controls the fishing line along the base fishing rod and as the fishing line is cast into the body of water, a metal tube stand that includes an elongated hollow tube with an orifice, the orifice receives and secures the base fishing rod while the user is ice-fishing, the metal tube stand having a plurality of support handles and a plurality of pieces of illuminating tape that are disposed on the reel to illuminate the reel.

### TECHNICAL FIELD & BACKGROUND

Currently there are limited options for accessories that enable a user to enjoy ice fishing during any time of the season. In today's sporting industry, people are interested in finding ways that can assist them during challenging fishing excursions.

The present invention generally relates to a tip pole. More specifically, the invention is a fishing tip pole.

It is an object of the invention to provide a fishing tip pole that is provided with a flag to detect when a fish has struck the fishing tip pole.

It is an object of the invention to provide a fishing tip pole that utilizes illuminating tape to allow a user to utilize the fishing tip pole at night.

What is really needed is a fishing tip pole that is provided with a flag to detect when a fish has struck the fishing tip pole that utilizes illuminating tape to allow a user to utilize the fishing tip pole at night.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side view of a fishing tip pole, according to an embodiment of the present invention.

FIG. 1B illustrates a side view of a fishing tip pole, according to an embodiment of the present invention.

FIG. 1C illustrates a side view of a flag and a support handle of a reel of a fishing tip pole, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

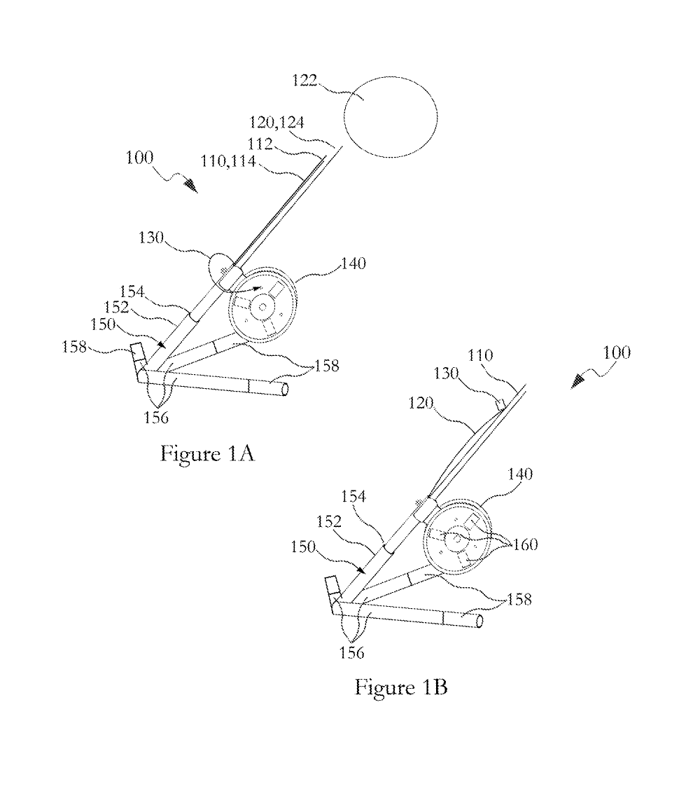

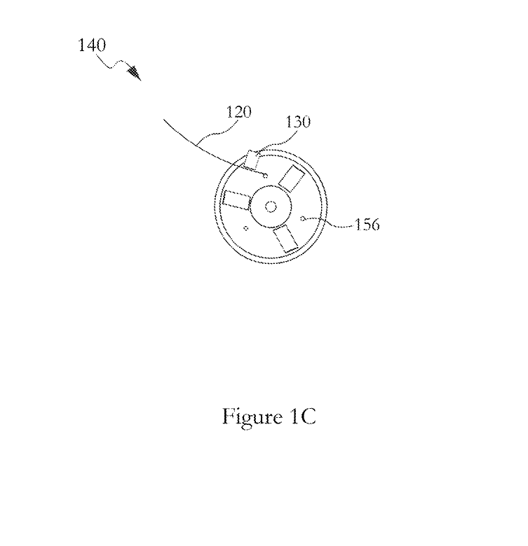

FIG. 1A illustrates a side view of a fishing tip pole 100, according to an embodiment of the present invention.

The fishing tip pole 100 includes a base fishing rod 110, a fishing line 120, a flag 130, a reel 140 and a metal tube stand 150. The base fishing rod 110 includes a first end 112 and is typically a traditional ice-fishing rod 114 but can be any suitable fishing rod. The fishing line 120 is run along the base fishing rod 110 and into a body of water 122 where a user desires to fish. The body of water 122 is typically a frozen lake, a frozen river, a frozen ocean or any other suitable body of water to go fishing. The fishing line 120 is typically a traditional ice-fishing line 124 but can be any suitable fishing line. The flag 130 is attached to the first end of the base fishing rod 110 and indicates to a user if a fish has struck the fishing line 120 by moving when the fish strikes the fishing line 120. The reel 140 is attached to the base fishing rod 110 and controls the fishing line 120 along the base fishing rod 110 and as the fishing line 120 is cast into the body of water 122. FIG. 1A illustrates the flag 130 attached on the fishing line 120 adjacent to the reel 140, however the flag 130 can be attached at any suitable position along the fishing line 120. The metal tube stand 150 includes an elongated hollow tube 152 with an orifice 154 that receives and secures the base fishing rod 110 while the user is ice-fishing and a plurality of support handles 156. FIG. 1A illustrates a metal tube stand 150 with 3 support handles 156 although the metal tube stand 150 can be supported by any suitable number of support handles such as 1 support handle, 2 support handles or 4 support handles. The support handles 156 each include a gripping surface 158 to facilitate grasping the support handles 156. The support handles 156 are made of wood but can be made of any suitable material such as metal, durable plastic or other suitable material. The support handles 156 are approximately ¼ inch in height by 1 inch in width but can be any suitable dimensions.

FIG. 1B illustrates a side view of a fishing tip pole 100, according to an embodiment of the present invention.

The fishing tip pole 100 illustrated and described in FIG. 1B and its description includes a base fishing rod 110, a fishing line 120, a flag 130, a reel 140 and a metal tube stand 150 that is similar to the base fishing rod 110, the fishing line 120, the flag 130, the reel 140 and the metal tube stand 150 illustrated and described in FIG. 1A and its description.

Additionally the fishing tip pole 100 includes a plurality of pieces of illuminating tape 160. The pieces of illuminating tape 160 are disposed on the reel 140 to illuminate the reel 140 to allow a user to fish at night or in darkness. FIG. 1B illustrates 3 pieces of illuminating tape 160 disposed on the reel 140 however any suitable number and sizes of pieces of illuminating tape can be disposed on the reel 140.

FIG. 1C illustrates a side view of a flag 130 and a support handle 156 of a reel 140 of a fishing tip pole 100, according to an embodiment of the present invention.

FIG. 1C also includes a fishing line 120. The fishing tip pole 100, the fishing line 120, the flag 130 and the support handles 156 illustrated in FIG. 1C is similar to the fishing tip pole 100, the fishing line 120, the flag 130, the reel 140 and the support handles 156 illustrated in FIG. 1A and FIG. 1B. As illustrated and in FIG. 1C, the flag 130 connects to one of the support handles 156 in contrast to FIG. 1A where the flag 130 connects to the fishing line 120.

The fishing tip pole is an ice fishing reel and rod holder that serves as a relatively convenient device when attempting to keep an ice-fishing line in water. Unlike traditional fishing rods and reels, the fishing tip pole has a flag at its end so that it's relatively easy to realize when a fish is striking a lure. The fishing tip pole has various settings for a relatively small strike or a relatively strong strike, providing relatively easy warning for those wearing thick gloves which tend to diminish the vibrations normally felt on a fishing line during warm weather fishing. The fishing tip pole may be readily available at renowned fishing supply retailers. The fishing tip pole is designed with an illuminating tape for night use which helps to locate the end of the fishing rod. The feature of a fishing pole with illuminating capabilities enables a fisherman to be proactive about catching a fish regardless of weather conditions.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A fishing tip pole, comprising:
a base fishing rod that includes a first end;
a fishing line run along the base fishing rod;
a flag attached to the base fishing rod, the flag indicates to a user if a fish has struck the fishing line by moving when the fish strikes the fishing line;
a reel attached to the base fishing rod, the reel controlling the fishing line along the base fishing rod and as the fishing line is cast into the body of water;
a metal tube stand that includes an elongated hollow tube with an orifice configured to receive and secure a fishing rod and having a plurality of support handles adapted to be grasped by a user's hands, wherein a portion of said base fishing rod is disposed in the metal tube; and
a plurality of pieces of illuminating tape that are disposed on the reel to illuminate the reel.

2-5. (canceled)

6. The fishing tip pole according to claim 1, wherein the metal tube stand has three support handles.

7. The fishing tip pole according to claim 1, wherein the support handles each include a gripping surface to facilitate grasping the support handles.

8-10. (canceled)

11. A fishing tip pole, comprising:
a base fishing rod that includes a first end;
a fishing line run along the base fishing rod;
a flag attached to the fishing line, the flag indicates to a user if a fish has struck the fishing line by moving when the fish strikes the fishing line;
a reel attached to the base fishing rod, the reel controls the fishing line along the base fishing rod and as the fishing line is cast into the body of water;
a metal tube stand that includes an elongated hollow tube with an orifice configured to receive and secure a fishing rod and having a plurality of support handles each including a gripping surface and adapted to be grasped by a user's hands on said gripping surface, wherein a portion of said base fishing rod is disposed in the metal tube; and
a plurality of pieces of illuminating tape that are disposed on the reel to illuminate the reel.

12-15. (canceled)

16. The fishing tip pole according to claim 11, wherein the flag is attached on the fishing line in a position adjacent to the reel.

17. The fishing tip pole according to claim 11, wherein the metal tube stand has three support handles.

18-20. (canceled)
